(19) United States
(12) Patent Application Publication
(10) Pub. No.: US 2025/0370866 A1
(43) Pub. Date: Dec. 4, 2025

(54) ON-DIE ERROR DETECTION AND CORRECTION FOR META DATA

(71) Applicant: Micron Technology, Inc., Boise, ID (US)

(72) Inventor: Scott E. Schaefer, Boise, ID (US)

(21) Appl. No.: 19/204,228

(22) Filed: May 9, 2025

Related U.S. Application Data
(60) Provisional application No. 63/652,537, filed on May 28, 2024.

(51) Int. Cl. G06F 11/10

(52) U.S. Cl. CPC G06F 11/1068; G06F 11/1048

(57) ABSTRACT

Methods, systems, and devices for on-die error detection and correction for meta data are described. A memory system may receive a write command associated with a first set of bits that includes data bits and meta data bits associated with the data bits and generate a second set of bits based on inputting the first set of bits into an error correction encoder. The second set of bits may include the data bits, the meta data bits, and parity bits. Upon generating the second set of bits, the memory system may store the meta data bits in at least a portion of a first memory space of the memory array of the memory system. The memory array may include the first memory space allocated for meta data and a second memory space allocated for data.

### CROSS REFERENCE

The present Application for Patent claims priority to U.S. Patent Application No. 63/652,537 by Schaefer, entitled “ON-DIE ERROR DETECTION AND CORRECTION FOR META DATA,” filed May 28, 2024, which is assigned to the assignee hereof, and which is expressly incorporated by reference in its entirety herein.

### TECHNICAL FIELD

The following relates to one or more systems for memory, including on-die error detection and correction for meta data.

### BACKGROUND

Memory devices are used to store information from devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports on-die error detection and correction for meta data in accordance with examples as disclosed herein.

FIG. 2 shows an example of a system that supports on-die error detection and correction for meta data in accordance with examples as disclosed herein.

FIG. 3 shows a block diagram of a memory system that supports on-die error detection and correction for meta data in accordance with examples as disclosed herein.

FIGS. 4 and 5 show flowcharts illustrating a method or methods that support on-die error detection and correction for meta data in accordance with examples as disclosed herein.

### DETAILED DESCRIPTION

A system, such as a host system, may instruct a second system, such as a memory system, to store meta data along with data (e.g., mission mode data, payload data, or other system characteristic information) in one or more locations, such as one or more memory arrays of the memory system. Meta data may provide basic information about the data (e.g., mission mode data, payload data, or other system characteristic information) and may allow the system, such as the host system, to make decisions regarding the data (e.g., mission mode data, payload data, or other system characteristic information) when the data and the meta data are read, for example, from the memory system. When the memory system receives a write command corresponding to the data, the memory system may store the data in the memory array and store the meta data associated with the data in one or more registers of the memory system. After some time, the memory system may transfer the meta data from the one or more registers to the memory array in response to one or more commands. However, transferring the meta data from the one or more registers to the one or more memory arrays may cause latency at the memory system. Further, while the meta data is stored in the one or more registers, the meta data may be vulnerable to errors which may result in invalid meta data being stored in the memory array and being sent to the host system.

As described herein, a memory system may concurrently store data and meta data associated with the data in one or more memory arrays. In some examples, the memory system may receive a write command from a host system instructing the memory system to store the data in the one or more memory arrays. Based on (e.g., in response to) the write command, the memory system may input the data and the meta data into an error correction encoder. The error correction encoder may output an error correction codeword that includes the data, the meta data, and parity information associated with the data and the meta data and forward the error correction codeword to the memory array for storage.

In some examples, the memory system may pre-allocate a first portion of the memory array for meta data and a second portion of the memory array for data. In such example, the memory system may store the meta data in the first portion of the memory array and the data in the second portion of the memory array. During a read operation for the data, the memory system may read the error correction codeword from the memory array and input the error correction codeword into an error correction decoder. If no errors in the error correction codeword are detected or if all errors in the error correction codeword are corrected, the error correction decoder may output the data and the meta data and the memory system may forward the data and the meta data to the host system.

Using the methods as described herein may allow the memory system to directly store the meta data in the memory array without the use of registers or other locations, which may decrease read and write latency compared to other different methods, among other advantages. Further, the methods described herein may apply error correction protection to the meta data in a faster and improved manner compared to other different methods, which may decrease uncorrectable or undetectable errors in the meta data, among other advantages.

In addition to applicability in memory systems as described herein, techniques for on-die error detection and correction for meta data may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by removing additional commands related to accessing meta data, which may decrease processing or latency times, improve response times, or otherwise improve user experience, among other benefits.

Features of the disclosure are illustrated and described in the context of systems and architectures. Features of the disclosure are further illustrated and described in the context of flowcharts.

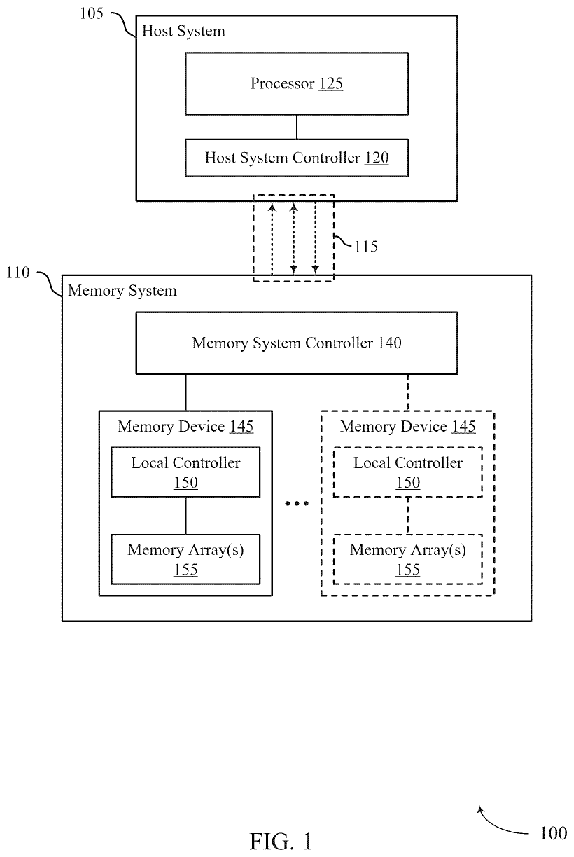

FIG. 1 illustrates an example of a system 100 that supports on-die error detection and correction for meta data in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

As described herein, the memory system 110 may concurrently store data and meta data associated with the data in the memory array 155. In some examples, the memory system 110 may receive a write command from the host system 105 instructing the memory system 110 to store the data in the memory array 155. In response to the write command, the memory system 110 may input the data and the meta data into an error correction encoder. The error correction encoder may output an error correction codeword that includes the data, the meta data, and parity information (e.g., bits) associated with the data and the meta data and forward the error correction codeword to the memory array 155 for storage.

In some examples, the memory system 110 may pre-allocate a first portion of the memory array 155 for meta data and a second portion of the memory array 155 for data. In such example, the memory system 110 may store the meta data in the first portion of the memory array 155 and the data in the second portion of the memory array 155. During a read operation for the data, the memory system 110 may read the error correction codeword from the memory array 155 and input the error correction codeword into an error correction decoder. If no errors in the error correction codeword are detected or if all errors in the error correction codeword are corrected, the error correction decoder may output the data and the meta data and the memory system 110 may forward the data and the meta data to the host system 105.

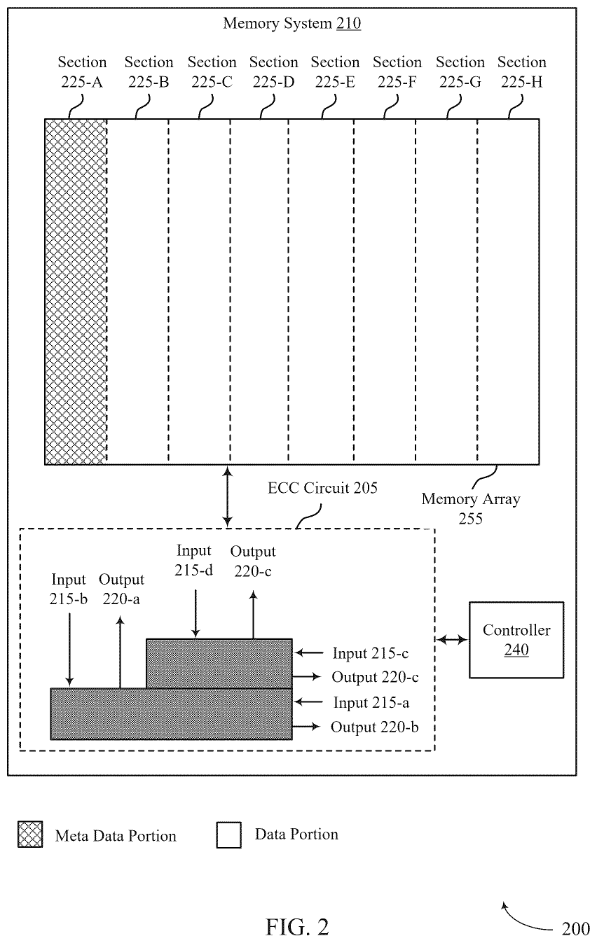

FIG. 2 shows an example of a system 200 that supports on-die error detection and correction for meta data in accordance with examples as disclosed herein. In some examples, the system 200 may support aspects of a system 100. For example, the system 200 may include a memory system 210 which may be an example of a memory system 110 as described with reference to FIG. 1. Further, the memory system 210 may include a controller 240 which may be an example of a memory system controller 140 or a local controller 150 as described with reference to FIG. 1.

In some examples, the memory system 210 may support different error correction modes. For example, the memory system 210 may support a first error correction mode and a second correction mode. The first error correction mode may be known as a meta data mode and the second error correction mode may be known as a data mode (or a base mode). In some examples, the memory system 210 may operate according to the first error correction mode when a host system coupled with the memory system 210 supports meta data storage. In some examples, the host system may instruct the memory system to store meta data along with data in a memory array 255 of the memory system 210. Meta data may summarize basic information about the data and when read, may help the host system sort and identify attributes of the data in an easier way than without the meta data.

In some examples, while operating according to the first error correction mode, the memory system 210 may allocate a first portion of the memory array 255 (or a first memory space) to meta data storage and a second portion of the memory array 255 (or a second memory space) to data storage. As shown in FIG. 2, the memory array 255 may be divided into multiple sections 225. For example, the memory system 210 may be divide the memory array 255 into a section 225-a, a section 225-b, a section 225-c, a section 225-d, a section 225-e, a section 225-f, a section 225-g, and a section 225-h. Each of the section may have a storage capacity of 256 bits and may be dedicated for either meta data storage or data storage. In the example of FIG. 2, the memory system 210 may dedicate the section 225-a for meta data storage and the sections 225-b through 225-h for data storage. In some examples, the first portion of the memory array 255 allocated for meta data storage may be programmable.

While operating according to the first error correction mode, the memory system 210 (or the controller 240) may receive a write command from the host system. The write command may indicate to write a first set of bits to the memory array 255. In some examples, the first set of bits may include data bits and meta data bits associated with the data bits. Upon receiving the write command, the controller 240 may forward the first set of bits to an ECC circuit 205 of the memory system 210 or more specifically, an ECC encoder within the ECC circuit 205. The ECC encoder may include circuitry operable to generate parity bits (or ECC bits) based on an input 215 to the ECC encoder. An output 220 of the ECC encoder may include the input 215 plus the generated parity bits. The parity bits may enable the memory system 210 to detect errors (e.g., single bit errors (SBEs) or double bit errors (DBEs)) and potentially correct the detected errors (e.g., SBEs) during a read operation.

In the example of FIG. 2, an input 215-a to the ECC encoder may include the first set of bits (e.g., the data bits and the meta bits) and an output 220-a of the ECC encoder may include a second set of bits (e.g., the data bits, the meta data bits, and parity bits associated with the data bits and/or the meta data bits). In some examples, a quantity of bits included in the first set of bits may include 272 bits (e.g., 256 bits of data plus 16 bits of meta data) and a quantity of bits included in the second set of bits may include 288 bits (e.g., 256 bits of data plus 16 bits of meta data plus 16 bits of parity bits). In another example, the quantity of bits included in the first set of bits may include 256 bits (e.g., 240 bits of data plus 16 bits of meta data) and the quantity of bits included in the second set of bits may include 272 bits (e.g., 256 bits of data plus 16 bits of meta data plus 16 bits of parity bits). However, other quantities of bits are possible. For example, the quantity of bit included in the meta data bits may range from 8 bits to 16 bits.

After outputting the second set of bits, the ECC circuit 205 may forward the second set of bits to the memory array 255. In some examples, the memory system 210 may store the meta data bits of the second set of bits in the first portion of the memory array allocated for meta data storage (e.g., the section 225-a) and the data bits of the second set of bits in the second portion of the memory array allocated for data storage (e.g., the section 225-b). In some examples, the memory system 210 may store the parity bits in the second portion of the memory array allocated for data storage or the memory system 210 may store the parity bits in a third portion of the memory array allocated for ECC storage (not shown in FIG. 2).

In other examples, the memory system 210 may not allocate a portion of the memory array 255 to meta data storage. Instead, the memory system 210 may allocate at least a portion of the memory array 255 to both meta data storage and data storage. That is, the memory system 210 may write the meta data bits (e.g., 16 meta data bits) to a first set of memory cells of a section 225 and the data bits (e.g., 240 data bits) to a second set of memory cells of the section 225.

In some examples, while operating according to the first error correction mode, the memory system 210 (or the controller 240) may receive a read command for the first set of bits. The read command may indicate to read the first set of bits from the memory array 255. Upon receiving the read command, the memory system 210 may retrieve (e.g., read) a third set of bits from the memory array 255 (e.g., the second set of bits written to the memory array) and forward the third set of bits to the ECC circuit 205 of the memory system 210 or more specifically, an ECC decoder within the ECC circuit 205. The ECC decoder may include circuitry operable to detect errors and potentially correct the detected errors in data. The ECC decoder may do this by comparing first parity bits (e.g., parity bits stored in the memory array 255 along with the data) with second parity bits (e.g., parity bits generated at the ECC decoder based on the data read from the memory array 255), among other operations.

In the example of FIG. 2, an input 215-b to the ECC decoder may be the third set of bits read from the memory array 255 and if no errors are present or if all detected errors are corrected, an output 220-b of the ECC decoder may include the first set of bits (e.g., the data bits plus the meta data bits). After outputting the first set of bits, the ECC circuit 205 may forward the first set of bits to the controller 240 and the controller 240 may transmit the first set of bits to the host system.

Alternatively, the memory system 210 may operate according to the second error correction mode and while operating according to second error correction mode, the memory system 210 may allocate the memory array 255 to data storage. That is, the memory system 210 may dedicate the sections 225-a through 225-h for data storage. Further, while operating according to the second error correction mode, the memory system 210 (or the controller 240) may receive a write command from the host system. The write command may indicate to write a fourth set of bits to the memory array 255. In some examples, the fourth set of bits may include second data bits (and no meta data bits associated with the second data bits). Upon receiving the write command, the controller 240 may forward the fourth set of bits to the ECC circuit 205 of the memory system 210 or more specifically, the ECC encoder within the ECC circuit 205.

In the example of FIG. 2, an input 215-c to the ECC encoder may include the fourth set of bits (e.g., the second data bits) and an output 220-c of the ECC encoder may include a fifth set of bits (e.g., the second data bits and second parity bits associated with the second data bits). In some examples, a quantity of bits included in the fourth set of bits may include 256 bits (e.g., 256 bits of second data) and a quantity of bits included in the fifth set of bits may include 272 bits (e.g., 256 bits of second data plus 16 bits of second parity information). However, other quantities of bits are possible.

After outputting the fifth set of bits, the ECC circuit 205 may forward the fifth set of bits to the memory array 255. In some examples, the memory system 210 may store the second data bits of the fifth set of bits in the portion of the memory array allocated for data storage (e.g., one of the sections 225-a through 225-h). In some examples, the memory system 210 may store the second parity bits in the portion of the memory array allocated for data storage (e.g., one of the sections 225-a through 225-h) or the memory system 210 may store the parity bits in a different portion of the memory array 255 allocated for ECC storage (not shown in FIG. 2).

In some examples, while operating according to the second error correction mode, the memory system 210 (or the controller 240) may receive a read command for the fourth set of bits. The read command may indicate to read the fourth set of bits from the memory array 255. Upon receiving the read command, the memory system 210 may retrieve (e.g., read) a sixth set of bits from the memory array 255 (e.g., the fourth set of bits written to the memory array) and forward the sixth set of bits to the ECC circuit 205 of the memory system 210 or more specifically, an ECC decoder within the ECC circuit 205.

In the example of FIG. 2, an input 215-d to the ECC decoder may be the sixth set of bits read from the memory array 255 and if no errors are present or if all detected errors are corrected, an output 220-d of the ECC decoder may include the fourth set of bits (e.g., the data second data bits). After outputting the fourth set of bits, the ECC circuit 205 may forward the fourth set of bits to the controller 240 and the controller 240 may transmit the fourth set of bits to the host system.

In some examples, the memory system 210 may include a single ECC circuit 205 that supports both the first error correction mode and the second error correction mode. For example, the memory system 210 may utilize a single ECC circuit 205 if a size (e.g., a quantity of bits) of the input 215 to the ECC encoder of the ECC circuit 205 is the same for both error correction modes. For example, if a size of the input 215-a is equal to 256 bits (e.g., 240 bits of data plus 16 bits of meta data) and a size of the input 215-c is equal to 256 bits (e.g., 256 bits of data), a single ECC circuit 205 may be used.

However, if the size of the inputs 215 for the different error corrections modes are different, the single ECC circuit 205 may employ a selectable ECC H-matrix. That is, the ECC circuit 205 may activate or deactivate different combinations of circuit components based on whether the memory system 210 is operating according to the first error correction mode or the second error correction mode. For example, while operating according to the second error correction mode (e.g., employing a first H-matrix), a first combination of logic gates may be in an activated state and while operating according to the first error correction mode (e.g., employing a second H-matrix) a second combination of logic gates may be in the activated state.

Alternatively, the memory system 210 may include two different ECC circuits 205. For example, the memory system 210 may include a first ECC circuit 205 and a second ECC circuit 205 (not shown in FIG. 2). The first ECC circuit 205 may be configured to encode and decode meta data plus data while the memory system 210 operates according to the first error correction mode and the second ECC circuit 205 may be configured to encode and decode data while the memory system 210 is operating according to the second error correction mode. The memory system 210 may activate one of the first ECC circuit 205 or the second ECC circuit 205 when switching between different error correction modes.

In some examples, at power up, the memory system 210 may be configured to operate according to either the first error correction mode or the second error correction mode (e.g., via signaling from the host system). As another option, the memory system 210 may dynamically switch between the first error correction mode and the second error correction mode (e.g., via signaling from the host system or internal triggers). Using the methods as described herein, the memory system 210 may write or read data and meta data corresponding to the read data during a same duration which may reduce write or read latency when compared to other methods.

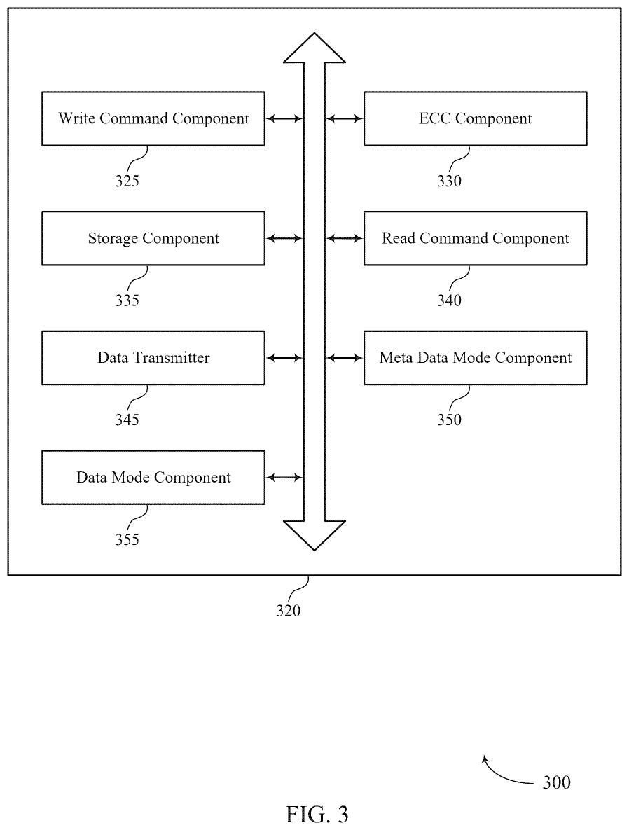

FIG. 3 shows a block diagram 300 of a memory system 320 that supports on-die error detection and correction for meta data in accordance with examples as disclosed herein. The memory system 320 may be an example of aspects of a memory system as described with reference to FIGS. 1 through 2. The memory system 320, or various components thereof, may be an example of means for performing various aspects of on-die error detection and correction for meta data as described herein. For example, the memory system 320 may include a write command component 325, a ECC component 330, a storage component 335, a read command component 340, a data transmitter 345, a meta data mode component 350, a data mode component 355, or any combination thereof. Each of these components, or components of subcomponents thereof (e.g., one or more processors, one or more memories), may communicate, directly or indirectly, with one another (e.g., via one or more buses).

The write command component 325 may be configured as or otherwise support a means for receiving a write command associated with a first set of bits, the first set of bits including data bits and meta data bits associated with the data bits. The ECC component 330 may be configured as or otherwise support a means for generating a second set of bits based at in part on inputting the first set of bits into an error correction encoder, the second set of bits including the data bits, the meta data bits, and parity bits associated with one or both of the data bits or the meta data bits. The storage component 335 may be configured as or otherwise support a means for storing the second set of bits in a memory array of the memory system, where the memory array includes a first memory space allocated for meta data and a second memory space allocated for data, and where the meta data bits are stored in at least a portion of the first memory space.

In some examples, the meta data mode component 350 may be configured as or otherwise support a means for receiving, prior to receiving the write command, first signaling enabling a first error correction mode at the memory system, where generating the second set of bits is based at least in part on receiving the first signaling.

In some examples, the meta data mode component 350 may be configured as or otherwise support a means for updating a state of one or more circuit components of the error correction encoder to one of an activated state or a deactivated state based at least in part on receiving the first signaling.

In some examples, the data mode component 355 may be configured as or otherwise support a means for receiving, after storing the second set of bits in the memory array of the memory system, second signaling enabling a second error correction mode at the memory system, the second error correction mode different from the first error correction mode.

In some examples, the data mode component 355 may be configured as or otherwise support a means for updating a state of one or more circuit components of the error correction encoder to one of an activated state or a deactivated state based at least in part on receiving the second signaling.

In some examples, the write command component 325 may be configured as or otherwise support a means for receiving a second write command associated with a third set of bits, the third set of bits including second data bits. In some examples, the ECC component 330 may be configured as or otherwise support a means for generating a fourth set of bits based at in part on inputting the third set of bits into the error correction encoder, the fourth set of bits including the data bits and second parity bits associated with the data bits. In some examples, the storage component 335 may be configured as or otherwise support a means for storing the fourth set of bits in the first memory space of the memory array.

In some examples, the ECC component 330 may be configured as or otherwise support a means for deactivating the error correction encoder based at least in part on receiving the second signaling. In some examples, the ECC component 330 may be configured as or otherwise support a means for activating a second error correction encoder based at least in part on receiving the second signaling.

In some examples, the write command component 325 may be configured as or otherwise support a means for receiving a second write command associated with a third set of bits, the third set of bits including second data bits. In some examples, the ECC component 330 may be configured as or otherwise support a means for generating a fourth set of bits based at in part on inputting the third set of bits into the second error correction encoder, the fourth set of bits including the data bits and second parity bits associated with the data bits. In some examples, the storage component 335 may be configured as or otherwise support a means for storing the fourth set of bits in the first memory space of the memory array.

The read command component 340 may be configured as or otherwise support a means for receiving a read command associated with data bits. In some examples, the storage component 335 may be configured as or otherwise support a means for reading, from a memory array of the memory system, a first set of bits including the data bits, meta data bits corresponding to the first set of bits, and parity bits associated with one or both of the data bits or the meta data bits, where the memory array includes a first memory space allocated for meta data and a second memory space allocated for data, and where the meta data bits are stored in at least a portion of the first memory space. In some examples, the ECC component 330 may be configured as or otherwise support a means for generating a second set of bits based at in part on inputting the first set of bits into an error correction decoder, the second set of bits including the data bits and the meta data bits. The data transmitter 345 may be configured as or otherwise support a means for transmitting the second set of bits based at least in part on generating the second set of bits.

In some examples, the meta data mode component 350 may be configured as or otherwise support a means for receiving, prior to receiving the read command, first signaling enabling a first error correction mode at the memory system, where generating the second set of bits is based at least in part on receiving the first signaling.

In some examples, the meta data mode component 350 may be configured as or otherwise support a means for updating a state of one or more circuit components of the error correction decoder to one of an activated state or a deactivated state based at least in part on receiving the first signaling.

In some examples, the data mode component 355 may be configured as or otherwise support a means for receiving, after transmitting the second set of bits, second signaling enabling a second error correction mode at the memory system, the second error correction mode different from the first error correction mode.

In some examples, the data mode component 355 may be configured as or otherwise support a means for updating a state of one or more circuit components of the error correction decoder to one of an activated state or a deactivated state based at least in part on receiving the second signaling.

In some examples, the read command component 340 may be configured as or otherwise support a means for receiving a second read command associated with second data bits. In some examples, the storage component 335 may be configured as or otherwise support a means for reading, from the second memory space of the memory array, a third set of bits including the second data bits and second parity bits associated with the second data bits. In some examples, the ECC component 330 may be configured as or otherwise support a means for generating a fourth set of bits based at in part on inputting the third set of bits into the error correction decoder, the fourth set of bits including the second data bits. In some examples, the data transmitter 345 may be configured as or otherwise support a means for transmitting the fourth set of bits based at least in part on generating the fourth set of bits.

In some examples, the ECC component 330 may be configured as or otherwise support a means for deactivating the error correction decoder based at least in part on receiving the second signaling. In some examples, the ECC component 330 may be configured as or otherwise support a means for activating a second error correction decoder based at least in part on receiving the second signaling.

In some examples, the read command component 340 may be configured as or otherwise support a means for receiving a second read command associated with second data bits. In some examples, the storage component 335 may be configured as or otherwise support a means for reading, from the second memory space of the memory array, a third set of bits including the second data bits and second parity bits associated with the second data bits. In some examples, the ECC component 330 may be configured as or otherwise support a means for generating a fourth set of bits based at in part on inputting the third set of bits into the second error correction decoder, the fourth set of bits including the second data bits. In some examples, the data transmitter 345 may be configured as or otherwise support a means for transmitting the fourth set of bits based at least in part on generating the fourth set of bits.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

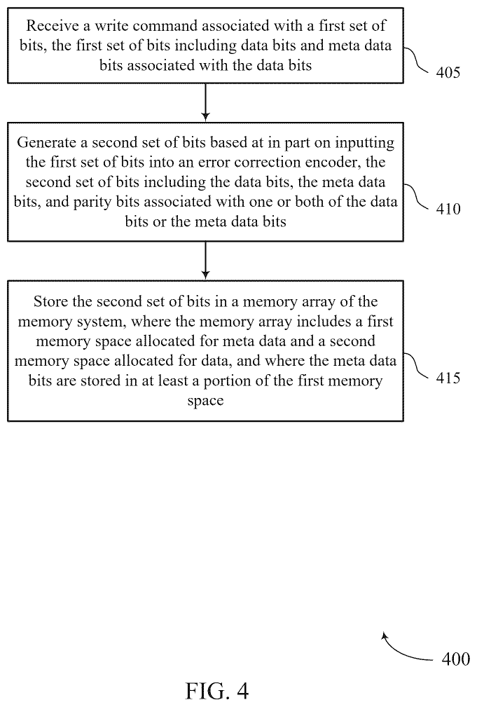

FIG. 4 shows a flowchart illustrating a method 400 that supports on-die error detection and correction for meta data in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include receiving a write command associated with a first set of bits, the first set of bits including data bits and meta data bits associated with the data bits. In some examples, aspects of the operations of 405 may be performed by a write command component 325 as described with reference to FIG. 3.

At 410, the method may include generating a second set of bits based at in part on inputting the first set of bits into an error correction encoder, the second set of bits including the data bits, the meta data bits, and parity bits associated with one or both of the data bits or the meta data bits. In some examples, aspects of the operations of 410 may be performed by a ECC component 330 as described with reference to FIG. 3.

At 415, the method may include storing the second set of bits in a memory array of the memory system, where the memory array includes a first memory space allocated for meta data and a second memory space allocated for data, and where the meta data bits are stored in at least a portion of the first memory space. In some examples, aspects of the operations of 415 may be performed by a storage component 335 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a write command associated with a first set of bits, the first set of bits including data bits and meta data bits associated with the data bits; generating a second set of bits based at in part on inputting the first set of bits into an error correction encoder, the second set of bits including the data bits, the meta data bits, and parity bits associated with one or both of the data bits or the meta data bits; and storing the second set of bits in a memory array of the memory system, where the memory array includes a first memory space allocated for meta data and a second memory space allocated for data, and where the meta data bits are stored in at least a portion of the first memory space.

Aspect 2: The method, apparatus, or non-transitory computer-readable medium of aspect 1, further including operations, features, circuitry, logic, means, or instructions, or any combination thereof for receiving, prior to receiving the write command, first signaling enabling a first error correction mode at the memory system, where generating the second set of bits is based at least in part on receiving the first signaling.

Aspect 3: The method, apparatus, or non-transitory computer-readable medium of aspect 2, further including operations, features, circuitry, logic, means, or instructions, or any combination thereof for updating a state of one or more circuit components of the error correction encoder to one of an activated state or a deactivated state based at least in part on receiving the first signaling.

Aspect 4: The method, apparatus, or non-transitory computer-readable medium of any of aspects 2 through 3, further including operations, features, circuitry, logic, means, or instructions, or any combination thereof for receiving, after storing the second set of bits in the memory array of the memory system, second signaling enabling a second error correction mode at the memory system, the second error correction mode different from the first error correction mode.

Aspect 5: The method, apparatus, or non-transitory computer-readable medium of aspect 4, further including operations, features, circuitry, logic, means, or instructions, or any combination thereof for updating a state of one or more circuit components of the error correction encoder to one of an activated state or a deactivated state based at least in part on receiving the second signaling.

Aspect 6: The method, apparatus, or non-transitory computer-readable medium of aspect 5, further including operations, features, circuitry, logic, means, or instructions, or any combination thereof for receiving a second write command associated with a third set of bits, the third set of bits including second data bits; generating a fourth set of bits based at in part on inputting the third set of bits into the error correction encoder, the fourth set of bits including the data bits and second parity bits associated with the data bits; and storing the fourth set of bits in the first memory space of the memory array.

Aspect 7: The method, apparatus, or non-transitory computer-readable medium of any of aspects 4 through 6, further including operations, features, circuitry, logic, means, or instructions, or any combination thereof for deactivating the error correction encoder based at least in part on receiving the second signaling and activating a second error correction encoder based at least in part on receiving the second signaling.

Aspect 8: The method, apparatus, or non-transitory computer-readable medium of aspect 7, further including operations, features, circuitry, logic, means, or instructions, or any combination thereof for receiving a second write command associated with a third set of bits, the third set of bits including second data bits; generating a fourth set of bits based at in part on inputting the third set of bits into the second error correction encoder, the fourth set of bits including the data bits and second parity bits associated with the data bits; and storing the fourth set of bits in the first memory space of the memory array.

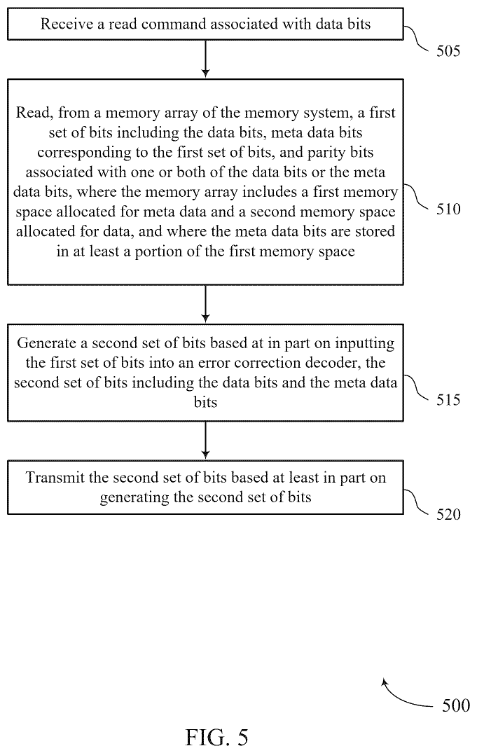

FIG. 5 shows a flowchart illustrating a method 500 that supports on-die error detection and correction for meta data in accordance with examples as disclosed herein. The operations of method 500 may be implemented by a memory system or its components as described herein. For example, the operations of method 500 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 505, the method may include receiving a read command associated with data bits. In some examples, aspects of the operations of 505 may be performed by a read command component 340 as described with reference to FIG. 3.

At 510, the method may include reading, from a memory array of the memory system, a first set of bits including the data bits, meta data bits corresponding to the first set of bits, and parity bits associated with one or both of the data bits or the meta data bits, where the memory array includes a first memory space allocated for meta data and a second memory space allocated for data, and where the meta data bits are stored in at least a portion of the first memory space. In some examples, aspects of the operations of 510 may be performed by a storage component 335 as described with reference to FIG. 3.

At 515, the method may include generating a second set of bits based at in part on inputting the first set of bits into an error correction decoder, the second set of bits including the data bits and the meta data bits. In some examples, aspects of the operations of 515 may be performed by a ECC component 330 as described with reference to FIG. 3.

At 520, the method may include transmitting the second set of bits based at least in part on generating the second set of bits. In some examples, aspects of the operations of 520 may be performed by a data transmitter 345 as described with reference to FIG. 3.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for receiving a read command associated with data bits; reading, from a memory array of the memory system, a first set of bits including the data bits, meta data bits corresponding to the first set of bits, and parity bits associated with one or both of the data bits or the meta data bits, where the memory array includes a first memory space allocated for meta data and a second memory space allocated for data, and where the meta data bits are stored in at least a portion of the first memory space; generating a second set of bits based at in part on inputting the first set of bits into an error correction decoder, the second set of bits including the data bits and the meta data bits; and transmitting the second set of bits based at least in part on generating the second set of bits.

Aspect 10: The method, apparatus, or non-transitory computer-readable medium of aspect 9, further including operations, features, circuitry, logic, means, or instructions, or any combination thereof for receiving, prior to receiving the read command, first signaling enabling a first error correction mode at the memory system, where generating the second set of bits is based at least in part on receiving the first signaling.

Aspect 11: The method, apparatus, or non-transitory computer-readable medium of aspect 10, further including operations, features, circuitry, logic, means, or instructions, or any combination thereof for updating a state of one or more circuit components of the error correction decoder to one of an activated state or a deactivated state based at least in part on receiving the first signaling.

Aspect 12: The method, apparatus, or non-transitory computer-readable medium of any of aspects 10 through 11, further including operations, features, circuitry, logic, means, or instructions, or any combination thereof for receiving, after transmitting the second set of bits, second signaling enabling a second error correction mode at the memory system, the second error correction mode different from the first error correction mode.

Aspect 13: The method, apparatus, or non-transitory computer-readable medium of aspect 12, further including operations, features, circuitry, logic, means, or instructions, or any combination thereof for updating a state of one or more circuit components of the error correction decoder to one of an activated state or a deactivated state based at least in part on receiving the second signaling.

Aspect 14: The method, apparatus, or non-transitory computer-readable medium of aspect 13, further including operations, features, circuitry, logic, means, or instructions, or any combination thereof for receiving a second read command associated with second data bits; reading, from the second memory space of the memory array, a third set of bits including the second data bits and second parity bits associated with the second data bits; generating a fourth set of bits based at in part on inputting the third set of bits into the error correction decoder, the fourth set of bits including the second data bits; and transmitting the fourth set of bits based at least in part on generating the fourth set of bits.

Aspect 15: The method, apparatus, or non-transitory computer-readable medium of any of aspects 12 through 14, further including operations, features, circuitry, logic, means, or instructions, or any combination thereof for deactivating the error correction decoder based at least in part on receiving the second signaling and activating a second error correction decoder based at least in part on receiving the second signaling.

Aspect 16: The method, apparatus, or non-transitory computer-readable medium of aspect 15, further including operations, features, circuitry, logic, means, or instructions, or any combination thereof for receiving a second read command associated with second data bits; reading, from the second memory space of the memory array, a third set of bits including the second data bits and second parity bits associated with the second data bits; generating a fourth set of bits based at in part on inputting the third set of bits into the second error correction decoder, the fourth set of bits including the second data bits; and transmitting the fourth set of bits based at least in part on generating the fourth set of bits.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a write command associated with a first set of bits, the first set of bits comprising data bits and meta data bits associated with the data bits;
generate a second set of bits based at in part on inputting the first set of bits into an error correction encoder, the second set of bits comprising the data bits, the meta data bits, and parity bits associated with one or both of the data bits or the meta data bits; and
store the second set of bits in a memory array of the memory system, wherein the memory array comprises a first memory space allocated for meta data and a second memory space allocated for data, and wherein the meta data bits are stored in at least a portion of the first memory space.

2. The memory system of claim 1, wherein the processing circuitry is further configured to cause the memory system to:
receive, prior to receiving the write command, first signaling enabling a first error correction mode at the memory system, wherein generating the second set of bits is based at least in part on receiving the first signaling.

3. The memory system of claim 2, wherein the processing circuitry is further configured to cause the memory system to:
update a state of one or more circuit components of the error correction encoder to one of an activated state or a deactivated state based at least in part on receiving the first signaling.

4. The memory system of claim 2, wherein the processing circuitry is further configured to cause the memory system to:
receive, after storing the second set of bits in the memory array of the memory system, second signaling enabling a second error correction mode at the memory system, the second error correction mode different from the first error correction mode.

5. The memory system of claim 4, wherein the processing circuitry is further configured to cause the memory system to:
update a state of one or more circuit components of the error correction encoder to one of an activated state or a deactivated state based at least in part on receiving the second signaling.

6. The memory system of claim 5, wherein the processing circuitry is further configured to cause the memory system to:
receive a second write command associated with a third set of bits, the third set of bits comprising second data bits;
generate a fourth set of bits based at in part on inputting the third set of bits into the error correction encoder, the fourth set of bits comprising the data bits and second parity bits associated with the data bits; and
store the fourth set of bits in the first memory space of the memory array.

7. The memory system of claim 4, wherein the processing circuitry is further configured to cause the memory system to:
deactivate the error correction encoder based at least in part on receiving the second signaling; and
activate a second error correction encoder based at least in part on receiving the second signaling.

8. The memory system of claim 7, wherein the processing circuitry is further configured to cause the memory system to:
receive a second write command associated with a third set of bits, the third set of bits comprising second data bits;
generate a fourth set of bits based at in part on inputting the third set of bits into the second error correction encoder, the fourth set of bits comprising the data bits and second parity bits associated with the data bits; and
store the fourth set of bits in the first memory space of the memory array.

9. A memory system, comprising:
one or more memory devices; and
processing circuitry coupled with the one or more memory devices and configured to cause the memory system to:
receive a read command associated with data bits;
read, from a memory array of the memory system, a first set of bits comprising the data bits, meta data bits corresponding to the first set of bits, and parity bits associated with one or both of the data bits or the meta data bits, wherein the memory array comprises a first memory space allocated for meta data and a second memory space allocated for data, and wherein the meta data bits are stored in at least a portion of the first memory space;
generate a second set of bits based at in part on inputting the first set of bits into an error correction decoder, the second set of bits comprising the data bits and the meta data bits; and
transmit the second set of bits based at least in part on generating the second set of bits.

10. The memory system of claim 9, wherein the processing circuitry is further configured to cause the memory system to:
receive, prior to receiving the read command, first signaling enabling a first error correction mode at the memory system, wherein generating the second set of bits is based at least in part on receiving the first signaling.

11. The memory system of claim 10, wherein the processing circuitry is further configured to cause the memory system to:
update a state of one or more circuit components of the error correction decoder to one of an activated state or a deactivated state based at least in part on receiving the first signaling.

12. The memory system of claim 10, wherein the processing circuitry is further configured to cause the memory system to:
receive, after transmitting the second set of bits, second signaling enabling a second error correction mode at the memory system, the second error correction mode different from the first error correction mode.

13. The memory system of claim 12, wherein the processing circuitry is further configured to cause the memory system to:
update a state of one or more circuit components of the error correction decoder to one of an activated state or a deactivated state based at least in part on receiving the second signaling.

14. The memory system of claim 13, wherein the processing circuitry is further configured to cause the memory system to:
receive a second read command associated with second data bits;
read, from the second memory space of the memory array, a third set of bits comprising the second data bits and second parity bits associated with the second data bits;
generate a fourth set of bits based at in part on inputting the third set of bits into the error correction decoder, the fourth set of bits comprising the second data bits; and
transmit the fourth set of bits based at least in part on generating the fourth set of bits.

15. The memory system of claim 12, wherein the processing circuitry is further configured to cause the memory system to:
deactivate the error correction decoder based at least in part on receiving the second signaling; and
activate a second error correction decoder based at least in part on receiving the second signaling.

16. The memory system of claim 15, wherein the processing circuitry is further configured to cause the memory system to:
receive a second read command associated with second data bits;
read, from the second memory space of the memory array, a third set of bits comprising the second data bits and second parity bits associated with the second data bits;
generate a fourth set of bits based at in part on inputting the third set of bits into the second error correction decoder, the fourth set of bits comprising the second data bits; and
transmit the fourth set of bits based at least in part on generating the fourth set of bits.

17. A method by a memory system, comprising:
receiving a write command associated with a first set of bits, the first set of bits comprising data bits and meta data bits associated with the data bits;
generating a second set of bits based at in part on inputting the first set of bits into an error correction encoder, the second set of bits comprising the data bits, the meta data bits, and parity bits associated with one or both of the data bits or the meta data bits; and
storing the second set of bits in a memory array of the memory system, wherein the memory array comprises a first memory space allocated for meta data and a second memory space allocated for data, and wherein the meta data bits are stored in at least a portion of the first memory space.

18. The method of claim 17, further comprising:
receiving, prior to receiving the write command, first signaling enabling a first error correction mode at the memory system, wherein generating the second set of bits is based at least in part on receiving the first signaling.

19. The method of claim 18, further comprising:
updating a state of one or more circuit components of the error correction encoder to one of an activated state or a deactivated state based at least in part on receiving the first signaling.

20. The method of claim 18, further comprising:
receiving, after storing the second set of bits in the memory array of the memory system, second signaling enabling a second error correction mode at the memory system, the second error correction mode different from the first error correction mode.

21. The method of claim 20, further comprising:
updating a state of one or more circuit components of the error correction encoder to one of an activated state or a deactivated state based at least in part on receiving the second signaling.

22. The method of claim 21, further comprising:
receiving a second write command associated with a third set of bits, the third set of bits comprising second data bits;
generating a fourth set of bits based at in part on inputting the third set of bits into the error correction encoder, the fourth set of bits comprising the data bits and second parity bits associated with the data bits; and
storing the fourth set of bits in the first memory space of the memory array.
